(19) United States
(12) Patent Application Publication
(10) Pub. No.: US 2004/0227688 A1
(43) Pub. Date: Nov. 18, 2004

(54) Metal plating of conductive loaded resin-based materials for low cost manufacturing of conductive articles

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 10/869,451

(22) Filed: Jun. 16, 2004

Related U.S. Application Data
(63) Continuation-in-part of application No. 10/309,429, filed on Dec. 4, 2002.
Application No. 10/309,429 is a continuation-in-part of application No. 10/075,778, filed on Feb. 14, 2002, now Pat. No. 6,741,221.
(60) Provisional application No. 60/478,917, filed on Jun. 16, 2003.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. G11B 33/02; H01Q 1/40

(52) U.S. Cl. 343/873

(57) ABSTRACT

Devices are formed of a conductive loaded resin-based material with a plated metal layer overlying. The conductive loaded resin-based material comprises micron conductive powder(s), conductive fiber(s), or a combination of conductive powder and conductive fibers in a base resin host. The ratio of the weight of the conductive powder(s), conductive fiber(s), or a combination of conductive powder and conductive fibers to the weight of the base resin host is between about 0.20 and 0.40. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, or the like.

This patent application claims priority to the U.S. Provisional Patent Application Ser. No. 60/478,917 filed on Jun. 16, 2003, which is herein incorporated by reference in its entirety.

This patent application is a Continuation-in-Part of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to conductive resin-based materials and, more particularly, to metal plating of conductive loaded resin-based materials comprising micron conductive powders, micron conductive fibers, or a combination thereof, homogenized within a base resin when molded. This manufacturing process yields a conductive part or material usable within the EMF or electronic spectrum(s).

(2) Description of the Prior Art

Resin-based articles of manufacture are used in a wide variety of applications. Resin-based materials offer low cost, very flexible manufacturing, excellent weight to strength ratio, and excellent resistance to environmental deterioration. While considering all of the advantages of resin-based materials, resin-based article of manufacture may suffer the disadvantage of looking like plastic. This is especially a concern for applications, such as in the arts of automotive or of plumbing, that have traditionally fabricated articles from metal. In these applications, customer acceptance of a “plastic faucet”, for example, may be a significant problem. Therefore, it is particularly advantageous to clad such resin-based articles in a metal layer. In addition, some resin-based articles of manufacture, such as food handling or medical devices may require a metal cladding for smoothness, ease of complete cleaning, etc. Further, typical resin-based articles of manufacture are thermal and/or electrical insulators and may require a metal cladding to improve thermal or electrical conductivity.

Several prior art inventions relate to metal plating of resin-based materials. U.S. Patent Publication US 2004/0086646 A1 to Brandes et al teaches a method of electroless metal plating on non-conductive surfaces, more specifically on (ABS) copolymers and (ABS) blends. U.S. Pat. No. 4,610,895 to Tubergen et al teaches a process for metallizing plastics by electroless deposition that is especially useful in the plating of foamed plastics, particularly a foamed blend of ABS and polyphenylene ether, foamed polycarbonate, foamed polystyrene, foamed ABS, foamed polyester, etc. U.S. Patent Publication US2002/0135519 A1 to Luch teaches the production of electrically conductive patterned surfaces and more specifically antennas and complex circuitry using directly electroplateable resins. The directly electroplateable resins (DER) comprise a mixture of carbon black and sulfur in the polymer matrix. Further, metal fillers may be added to the DER material. U.S. Pat. No. 4,429,020 teaches electrodeposition of a tin/metal layer over a DER as defined above.

### SUMMARY OF THE INVENTION

A principal object of the present invention is to provide an effective metal-plated, conductive loaded resin-based material.

A further object of the present invention is to provide a method to form a metal layer on a conductive loaded resin-based material.

A further object of the present invention is to provide various devices and structures formed of metal-plated, conductive loaded resin-based materials.

A yet further object of the present invention is to provide a method to alter visual, thermal, mechanical, and/or electrical characteristics of a conductive-loaded resin-based by forming a metal layer over the conductive loaded resin-based material.

A yet further object of the present invention is to provide a method to electrically and/or thermally interface a conductive loaded resin-based device or structure by means of a metal layer formed thereon.

In accordance with the objects of this invention, a device is achieved. The device comprises a conductive loaded, resin-based material comprising conductive materials in a base resin host. The base resin host is platable. A plated metal layer overlies the conductive loaded, resin-based material.

Also in accordance with the objects of this invention, a method to form a device is achieved. The method comprises providing a conductive loaded, resin-based material comprising conductive materials in a resin-based host. The conductive loaded, resin-based material is molded into a device. A metal layer overlies the device.

Also in accordance with the objects of this invention, a method to form a device is achieved. The method comprises providing a conductive loaded, resin-based material comprising conductive materials in a resin-based host. The conductive loaded, resin-based material is molded into a device. A metal layer overlies the device. A plated metal layer overlies the device. The plated metal layer is not formed over the non-platable masking layer.

### BRIEF DESCRIPTION OF THE DRAWINGS

In the accompanying drawings forming a material part of this description, there is shown:

FIGS. 1a through 1b illustrate a first preferred embodiment of the present invention showing a metal-plated conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold devices or structures of a conductive loaded resin-based material.

FIGS. 7a through 7c illustrates a second preferred embodiment of the present invention showing a metal-plated conductive loaded resin-based heat sink device. Electroless plating and electroplating are used to form the overlying metal layers.

FIG. 8 illustrates a third preferred embodiment of present invention showing a method of forming metal layers on a conductive loaded resin-based device.

FIGS. 9a and 9b illustrate a fourth preferred embodiment of the present invention showing a first method to selectively metal plate a conductive loaded resin-based article.

FIGS. 10a through 10d illustrate a fifth preferred embodiment of the present invention showing a second method to selectively metal plate a conductive loaded resin-based article.

FIG. 11 illustrates a sixth preferred embodiment of the present invention showing an antenna structure formed of the conductive loaded resin-based material with metal selectively plated onto the conductive loaded resin-based material to optimize the frequency response of the antenna.

FIG. 12 illustrates a seventh preferred embodiment of the present invention showing an antenna structure formed of the conductive loaded resin-based material with an overlying platable, resin-based material. A metal layer is selectively plated to optimize the frequency response of the antenna.

### DESCRIPTION OF THE PREFERRED EMBODIMENTS

This invention relates to molded conductive loaded resin-based materials comprising micron conductive powders, micron conductive fibers, or a combination thereof, homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of devices or structures fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the devices or structures are homogenized together using molding techniques and or methods such as injection molding, over-molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

The use of conductive loaded resin-based materials in the fabrication of devices or structures significantly lowers the cost of materials and the design and manufacturing processes used to hold ease of close tolerances, by forming these materials into desired shapes and sizes. The devices or structures can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are homogenized together within the base resin, during the molding process, yielding an easy to produce low cost, electrically conductive, close tolerance manufactured part or circuit. The micron conductive powders can be of carbons, graphites, amines or the like, and/or of metal powders such as nickel, copper, silver, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, or the like, or combinations thereof. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the heat sinks. The doping composition and directionality associated with the micron conductors within the loaded base resins can affect the electrical and structural characteristics of the devices or structures and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming devices or structures that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in applications as described herein.

The homogeneous mixing of micron conductive fiber and/or micron conductive powder and base resin described in the present invention may also be described as doping. That is, the homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the homogeneous mixing of micron conductive fiber and/or micron conductive powder into a base resin.

As an additional and important feature of the present invention, the molded conductor loaded resin-based material exhibits excellent thermal dissipation characteristics. Therefore, devices or structures manufactured from the molded conductor loaded resin-based material can provide added thermal dissipation capabilities to the application. For example, heat can be dissipated from electrical devices physically and/or electrically connected to devices or structures of the present invention.

As a significant advantage of the present invention, devices or structures constructed of the conductive loaded resin-based material can be easily interfaced to an electrical circuit or grounded. In one embodiment, a wire can be attached to the conductive loaded resin-based material via a screw that is fastened to the material. For example, a simple sheet-metal type, self tapping screw can, when fastened to the material, achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the devices or structures and a grounding wire.

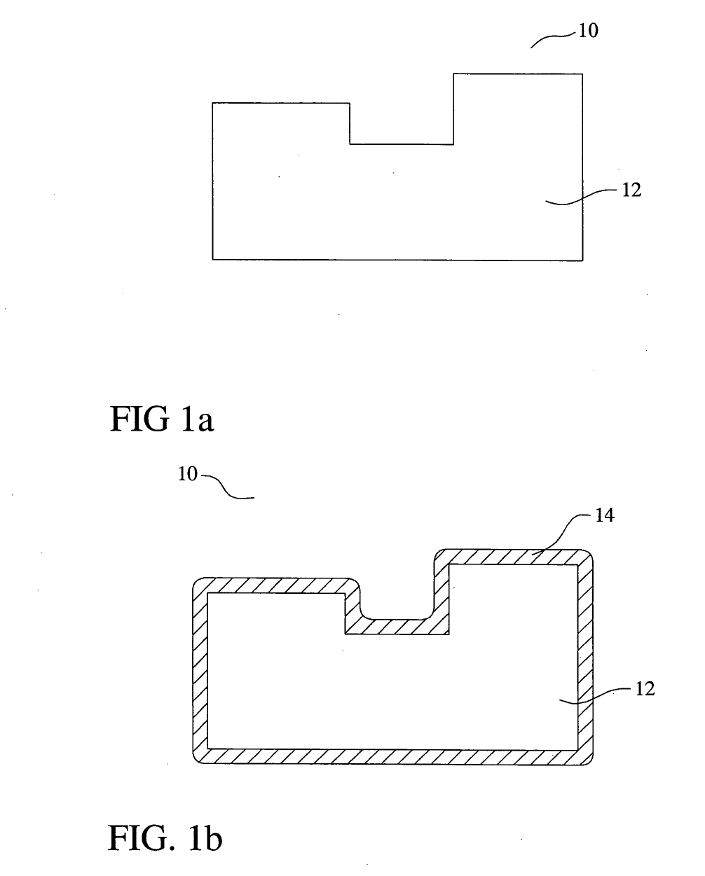

Referring now to FIGS. 1a and 1b, a first preferred embodiment of the present invention is illustrated. Several important features of the present invention are shown and discussed below. Referring now to FIG. 1a, an article of manufacture 10 is formed of the conductive loaded resin-based material 12 according to the present invention. The device or structure 10 is formed by molding the conductive loaded resin-based material 12. The material 12 is molded using any of the well-known molding processes, such as but not limited to injection molding or extrusion molding. In addition, post-molding processing, such as but not limited to milling, stamping, machining, drilling, is performed the conductive loaded resin-based material 12, as needed, to achieve the desired shape of the article 10.

Referring now to FIG. 1b, a most important feature of the present invention is illustrated. A metal layer 14 is plated onto the conductive loaded resin-based 12 to form a metal-plated article 10. The metal layer 14 is plated by electroplating or by electroless plating or by a combination of both electroplating and electroless plating as is described below. The resulting metal layer 14 bonds with the base resin of the conductive loaded resin-based or to both the base resin and the conductive loading material.

Electroplating is accomplished by immersing the conductive loaded resin-based article 10 into a plating solution. The plating solution comprises, in part, the metal species that is to be plated. For example, if tin is to be plated onto the article 10, then the plating solution comprises, in part, tin ions dissolved into the solution. An electrical potential is then established between the plating solution and the article 10. To accomplish this electrical potential, the conductive loaded resin-based article 10 is hung on a conductive rack or is placed into a conductive basket. A first electrical terminal is then connected to this conductive rack or basket. A second electrical terminal is then attached to the plating solution using, for example, a large piece of metal of the same type as is dissolved in the plating solution. A DC voltage is then established between the solution and the conductive loaded resin-based article by forcing a positive voltage onto the solution (ANODE) and a negative voltage onto the article 10 (CATHODE). The positively charged metal ions in the solution are attracted to the negatively charged article 10. As these metal ions plate, or bond to, the charged article 10, the ions take on electrons from the article 10 and, as a result, a net current flows from the ANODE to CATHODE. Further, as metal ions are removed from the solution due to plating, additional metal ions are added to the solution by dissolution from the metal ANODE. The rate of plating is controlled by the relative concentration of metal ions in the solution and the relative voltage potential between ANODE and CATHODE. In addition, the net amount of plated metal is carefully controlled by monitoring the net current flow in the circuit.

In one embodiment of the present invention, the plated metal layer 14 bonds with and secures itself primarily to the base resin of the conductive loaded resin-based material 12. In this case, the base resin is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. In another, more preferred, embodiment of the present invention, the plated metal layer 14 bonds with and secures itself to the conductive network of micron conductive fibers and/or micron conductive powders and to the base resin within the molded structure 12. In this case, the conductive loading material also comprises a material that bonds to the plated metal 14.

The above-described electroplating process may be repeated multiple times with solutions containing different plating species to thereby form a series of metal plating layers. In this way, optimal metal plating properties can be achieved. For example, a metal species with particularly good adhesion to the conductive loaded resin-based material is first plated. Next, an excellent wearing material is plated over the adhesion layer. Finally, an optimal appearance layer is plated over the wearing layer. Alternatively, an excellent conductor layer or solderable layer may be plated last according to the specific needs of the application.

While the electroplating process generally provides excellent quality and thickness control, it does have some serious drawbacks. First, the surfaces of the platable article 12 must be very clean prior to plating. Any dirt, grease, or defect on the surface will adversely affect the plating and may cause a failure to plating in those locations. Second, and more importantly, the plating surface must be universally of high conductivity. The conductive loaded resin-based material 12 of the present invention is of a highly conductive material due to the current bearing capability of the network of conductive fibers/particles homogeneously combined into the base resin. However, the base resin, itself, remains not conductive. Therefore, at the atomic level, individual molecules within the base resin will not readily bond with the plating metal ions based on a strictly electroplating mechanism. Further, it is found that particular topologies of the article's 12 surface, such as narrow spaces or holes, are very difficult to plate by electroplating. Therefore, it is necessary, in some cases, to first electroless plate a very thin layer of metal onto the surface of the conductive loaded resin-based article 12 prior to electroplating.

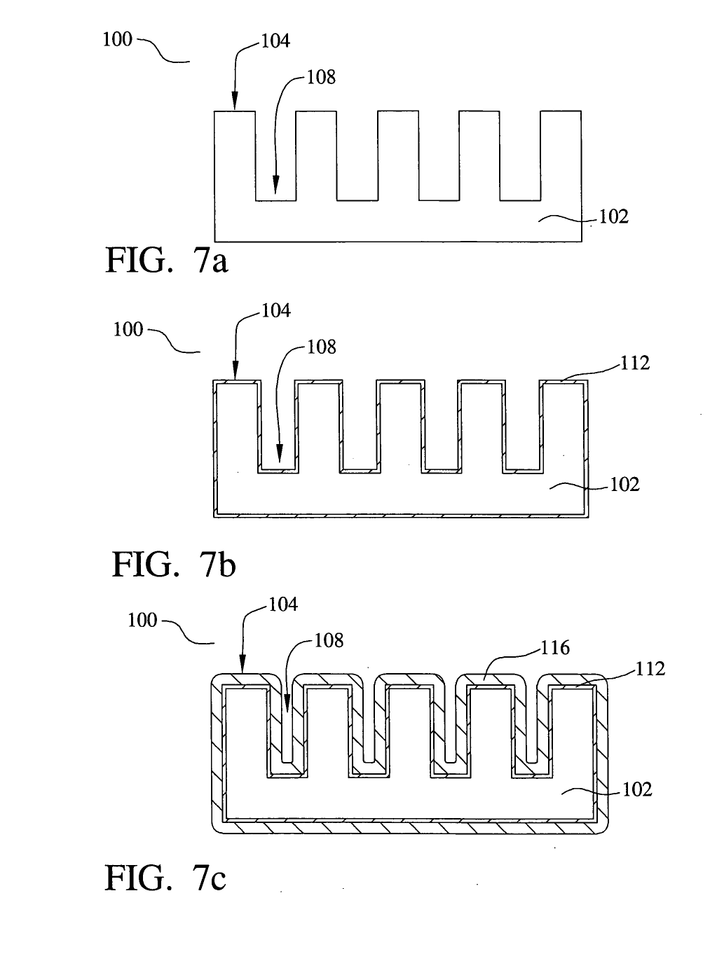

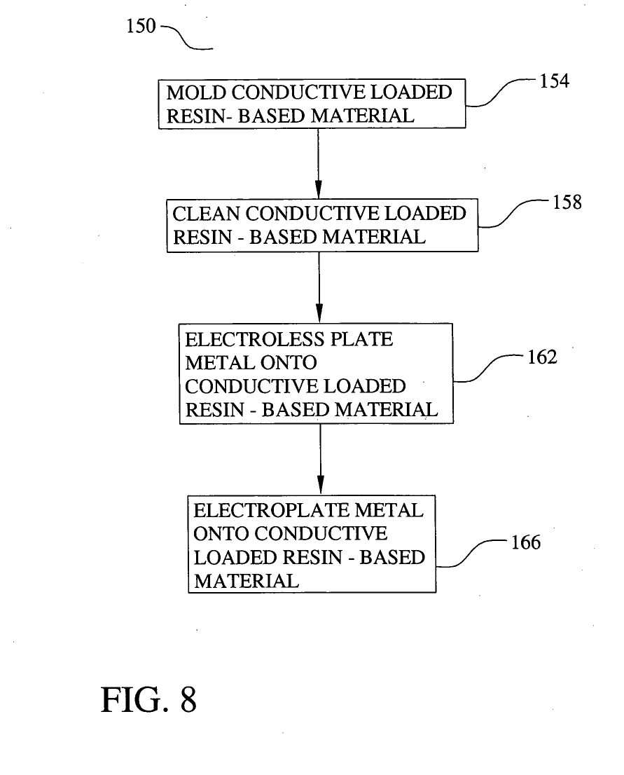

Referring now to FIGS. 7a through 7c, an example of a plating sequence using electroless plating followed by electroplating is shown. Further, FIG. 8 shows a flow diagram of this method of plating a conductive loaded resin-based article. In an electroless plating process, the plating is a chemical process not controlled by electrical current flow. Electroless plating typically uses a catalyst solution, such as tin-palladium, to provide a surface to initiate the electroless plating of the desired metal species. In the exemplary embodiment, a heat sink device 100 is first molded of the conductive loaded resin-based material 102 in step 154 of the method 150 illustrated in FIG. 8. A heat sink device 100 is illustrated in FIGS. 7a through 7c because it comprises fins or pins 104 to maximize the available surface area for convection heat transfer between the heat sink 100 and the surrounding environment. The fins or pins 104 create deep clefts 108 that are difficult to electroplate due to charge concentration effects. Therefore, it is particularly useful, in this case, to perform a first electroless plating operation.

After molding, the conductive loaded resin-based heat sink device 102 is cleaned to remove any molding residue, dirt, oil, and the like, in step 158 of FIG. 8. In a further embodiment, the surfaces of the device 102 are partially etched to prepare the device for plating. Next, the heat sink device 102 is electroless plated to form a very thin, first plated metal layer 112 in step 162 of FIG. 8. In the electroless process, the device 102 is immersed in a solution comprising a catalyst, such as tin-palladium. The catalyst is absorbed into the surface layer of the conductive loaded resin-based material 102 to create a very thin catalyst layer, not shown. Once again, the base resin of the conductive loaded resin-based material comprises one that can be metal plated as described above. Following the catalyst immersion, the heat sink device 100 is immersed into a solution containing the plating species. The electroless solution comprises a complex mix of the plating species, an oxidizing or reducing agent, a surface active agent, and a pH adjustor. The electroless plating solution reacts with the catalyst and the base resin surfaces. As a result, a thin layer 112 of the metal species is plated onto the heat sink surfaces. Any platable metal may be used. Exemplary platable metals include copper, tin, nickel, zinc, chromium, silver, gold, and the like.

The electroless plating process is typically more expensive, per unit thickness, and more difficult to control than the electroplating process. Therefore, after first plating metal 112 is deposited by electroless plating, the heat sink 100 is transferred to an electrolplating bath. In the electroplating bath, a second plating metal 116 is deposited using the electroplating process, as described above, in step 166. This second metal layer 116 is preferably thicker than the first metal layer 112 though this is not required in the present invention. Exemplary second platable metals include copper, tin, nickel, zinc, chromium, silver, gold, and the like. In addition, the first and second metal layer 112 and 116 may or may not be the same material. The presence of the first metal layer 112 provides a consistent conductive surface across the surface of the heat sink 100. In addition, the first metal layer 112 may catalyze the deposition reaction in the electroplating bath by providing an initial lattice for metal ion bonding. The two step sequence of electroless plating and electroplating facilitates conformal and defect free metal plating 112 and 116 over the surface of the heat sink device 100, even in areas 108 between pins or fins 104.

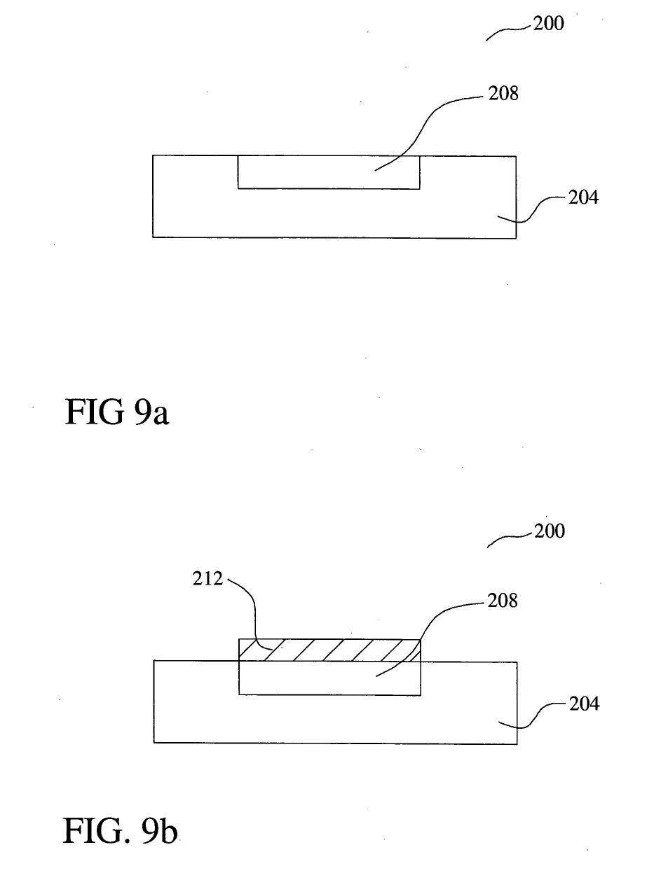

Referring now to FIGS. 9a and 9b, a fourth preferred embodiment of the present invention is illustrated. In this embodiment, a method 200 to selectively plate a metal layer over a conductive loaded resin-based structure is shown. Referring particularly to FIG. 9a, a partially completed device 200 is shown. The device 200 comprises two, distinct regions or parts. A first part 208 is molded of the conductive loaded resin-based material according to the present invention. More particularly, the first part 208 comprises a base resin that is metal platable such as, for example, any of the base resins described above. A second part 204 is any material that is not platable. More preferably, the second part comprises a resin-based material that is over-molded onto the first part 208. This second part 204 may further comprise a conductive loading as described in the present invention. However, the combined effect of the conductive loading and the base resin in the second part 204 of the device 200 is not sufficient to cause metal plating. More preferably, the second part 204 comprises a non-conductive and non-platable material.

As can be seen in FIG. 9a, the first part 208 and second part 204 of the device 200 form two distinct regions in the overall device. Referring now to FIG. 9b, the device 200 is then immersed into a plating solution as part of an electroplating or an electroless plating process. As a result, a metal plating layer 212 is plated onto the conductive loaded resin-based material 208 of the first part 208 of the device 200. This metal plating layer may be formed by a single electroless plating step, a single electroplating step, or by a combined electroless and electroplating sequence as described above. The non-platability of the second part 208 material results in an absence of metal plating 212 in this area 204. Therefore, the result of the global or batch plating process is to selectively form a plated metal layer only over the platable conductive loaded resin-based section 208. As a result, if the conductive loaded resin-based region 208 is intended to conduct electric current or heat energy, the presence of the selectively plated metal layer 212 will serve to compliment this function by, for example, carrying additional current or thermal energy. However, this complimentary function will be limited to the conductive loaded resin-based area 208 and not, for example, cause current to flow over the second area 204 when this area is intended to be an electrical or thermal insulator. This selectivity is achieved without the additional application and patterning of a masking layer.

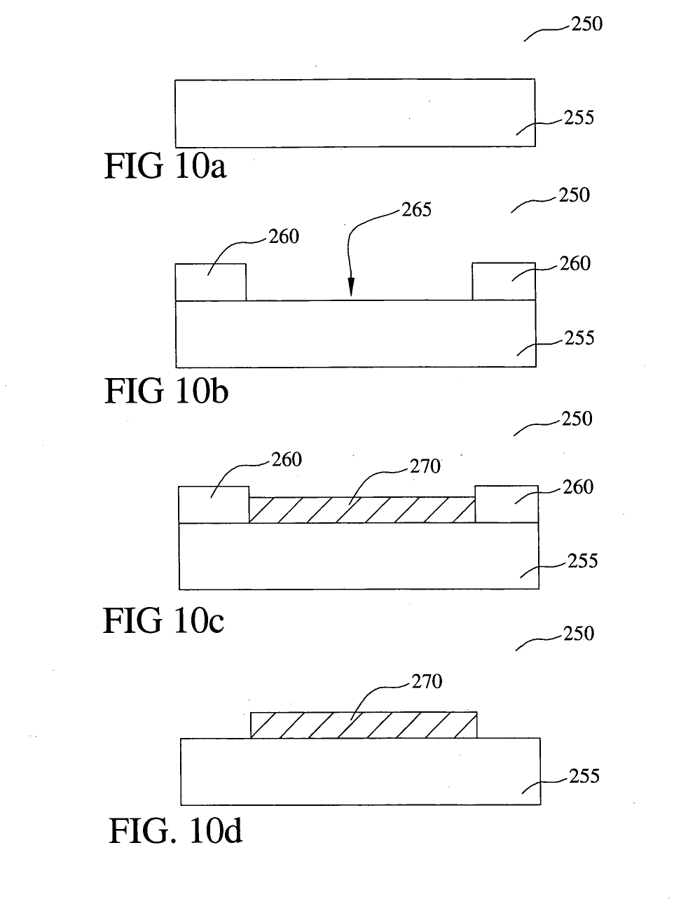

Referring now to FIGS. 10a through 10d, a fifth preferred embodiment of the present invention is illustrated. Another method to selectively plate a metal layer 270 onto a conductive loaded resin-based material 255 is shown. In this case, a device or structure 250 of the conductive loaded resin-based material has been previously molded according to the teachings of the present invention as shown in FIG. 10a. Referring now to FIG. 10b, after molding, a masking layer is applied and patterned overlying the conductive loaded resin-based material 255. This masking layer 260 comprises any of several types of materials.

In a first embodiment, the masking layer 260 comprises a polymer or resin-based ink, as well known in the art, that is printed onto the conductive loaded resin-based material 255. In one embodiment, this ink 260 is selectively applied by a screen printing technique. In another embodiment, this ink comprises a photosensitive ink, as is well known in the art. This photosensitive ink 260 is then patterned using a photolithographic technique. In a second embodiment, the masking layer 260 comprises a resin-based material that is over-molded onto the conductive loaded resin-based material 255. In either case, an opening is formed in the masking layer 260 to expose a portion of the underlying conductive loaded resin-based material 255.

Referring now to FIG. 10c, the device 250 is immersed in a plating solution as part of an electroplating or an electroplating process as described above. As a result, a metal plating layer 270 is plated onto the conductive loaded resin-based material 255 of the device 250. This metal plating layer may be formed by a single electroless plating step, a single electroplating step, or by a combined electroless and electroplating sequence as described above. The non-platability of the masking layer 260 results in an absence of metal plating 270 in this area. Therefore, the result of the global or batch plating process is to selectively form a plated metal layer 270 only over the platable conductive loaded resin-based section 255.

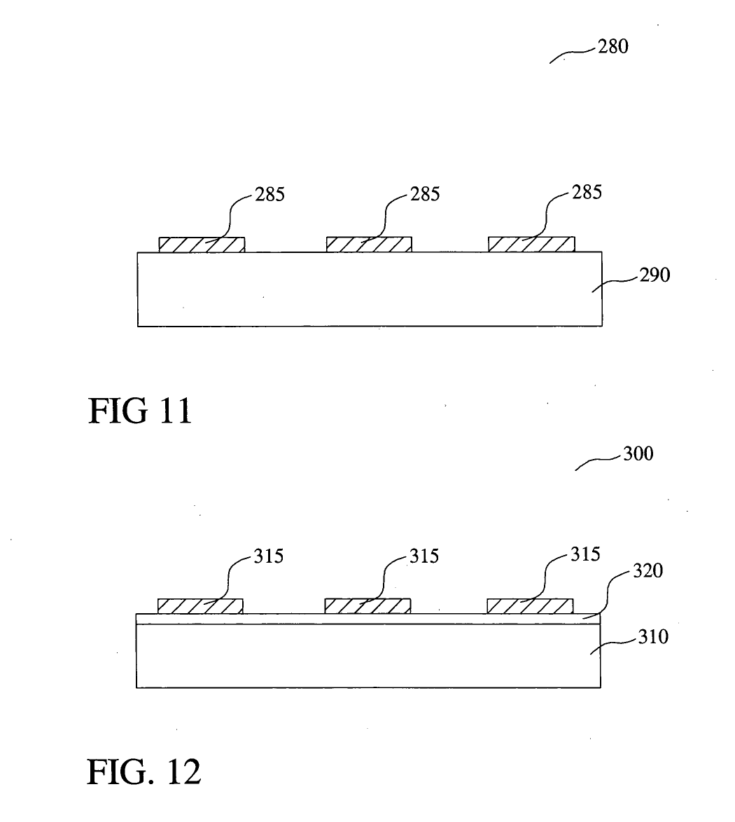

Referring now to FIG. 11, a sixth preferred embodiment of the present invention is illustrated. In this embodiment, the selectively plated metal layer 285 is applied to an antenna structure 280 molded of the conductive loaded resin-based material 290. A cross section of the antenna structure 280 is shown. For example, from a top view, not shown, a serpentine pattern or zig-zag pattern is formed in the conductive loaded resin-based material 290 and/or in the plated metal circuit layer 285 to form an antenna structure. The conductive loaded resin-based material 290 described in the present invention is particularly useful for forming antenna structures for a range of application, such as mobile communications systems. The conductive loaded resin-based material 290 absorbs electromagnetic energy over a large bandwidth. Further, this capability is combined with excellent physical and mechanical properties inherent in the base resin. In this embodiment, the conductive loaded resin-based antenna 290 is altered by selectively plating metal circuit layer 285 over the conductive loaded resin-based material. By carefully designing the plated metal circuit 285 pattern, an optimally tunable antenna 280 is achieved. The antenna 280 is tuned by the metal plating pattern 285 to create frequency resonance based on fractional multiples of the carrier wavelength (λ). In addition, the presence of the metal plating circuit layer 285 can further increase the frequency bandwidth of the antenna 290. Once again, the base resin of the conductive loaded resin-based material 290 is a platable material, such as described above. The above-described embodiment is also easily extended to non-antenna applications such as electronics circuits.

Referring now to FIG. 12, a seventh preferred embodiment of the present invention is illustrated. Another antenna structure 300 formed of the conductive loaded resin-based material 310 is shown. Again, a cross section of the antenna structure 300 is shown. In this case, a platable, insulating layer 320 is formed over the conductive loaded resin-based antenna 310. This platable, insulating layer 320 preferable comprises a resin-based material and, more preferably, comprises the same base resin as is used in the conductive loaded resin-based antenna 310. However, any platable material 320 may be used. In one embodiment, the platable, insulating layer 320 is over-molded onto a previously molded conductive loaded resin-based antenna 310. In another embodiment, the platable insulating layer 320 is applied to the previously molded conductive loaded resin-based antenna 310 by spraying, dipping, or coating. In yet another embodiment, the platable, insulating layer 320 is laminated onto the conductive loaded resin-based antenna 310 by an adhesive layer, not shown, or by a welding process.

As an important feature of this embodiment, a metal layer 315 is selectively plated onto the platable, insulating layer 320. In one embodiment, the metal circuit layer 315 is selectively plated by using a masking ink or layer, as described above, to define platable regions on the surface of the platable, insulating layer 320. The metal circuit layer 315 is then plated using electroless plating, electroplating, of a combination of both electroless plating and electroplating as described above. By using the intervening platable layer 320, this embodiment of the present invention allows a conductive loaded resin-based material 310 formulated with a non-platable base resin to be metal plated. Further, the insulating, platable layer 320 creates a capacitive and/or inductive coupling between the conductive loaded resin-based antenna structure 310 and the plated metal 315. As a result, another novel antenna 300 is achieved. Multiple resonance frequencies can be created by the presence of the capacitively coupled metal plating 315 on the conductive loaded resin-based antenna structure 310. The metal plating pattern 315 is another means to optimize the resonance frequency(s). The capacitive and/or inductive coupling of the metal plating 315 to the conductive loaded resin-based antenna structure 310 increases the bandwidth of the antenna by increasing the overall conducting surface area.

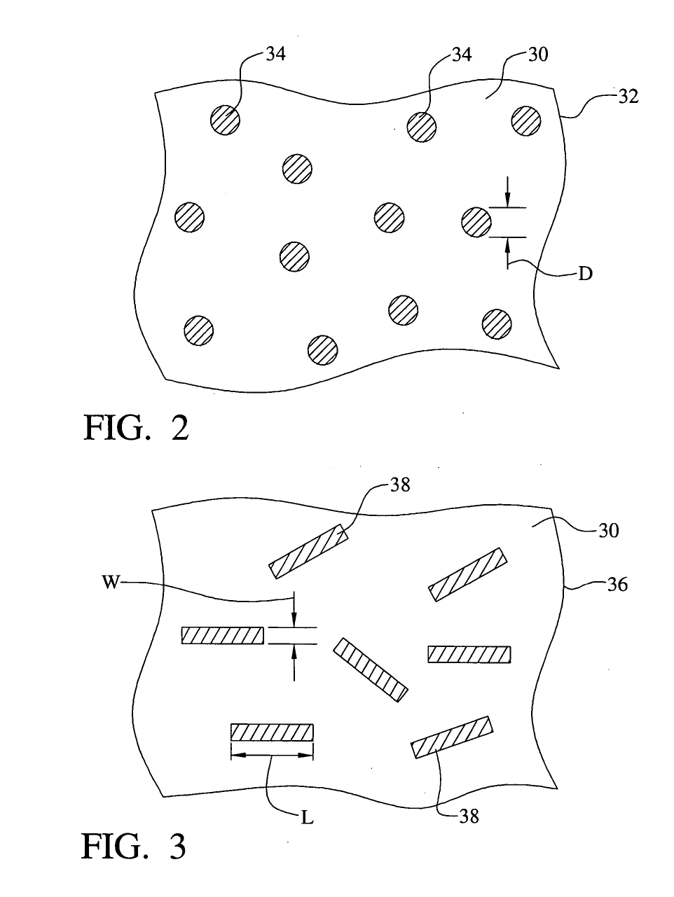

The conductive loaded resin-based material typically comprises a micron powder(s) of conductor particles and/or in combination of micron fiber(s) homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

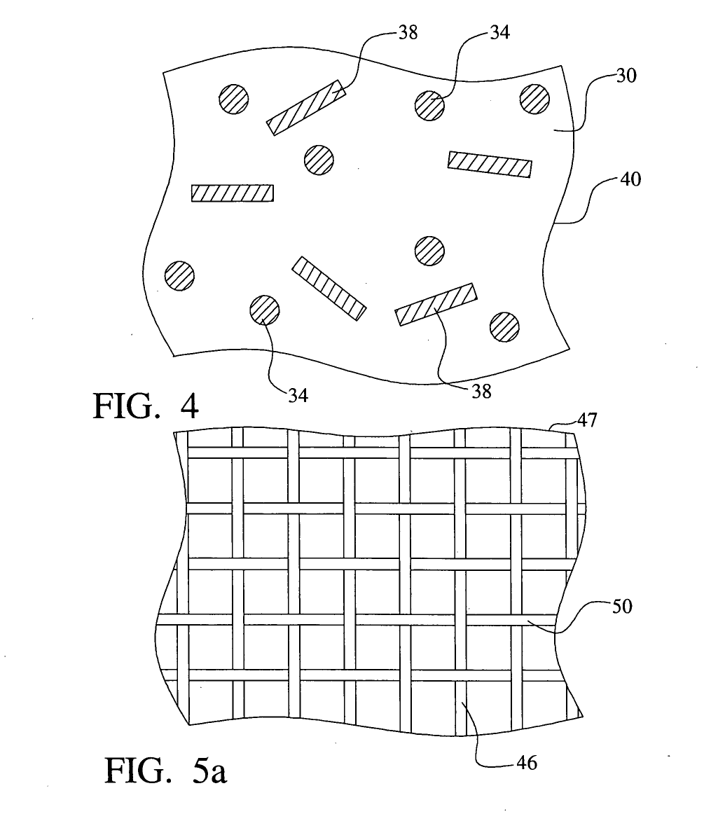

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, or other suitable metals or conductive fibers, or combinations thereof. These conductor particles and or fibers are homogenized within a base resin. As previously mentioned, the conductive loaded resin-based materials have a resistivity between about 5 and 25 ohms per square, other resistivities can be achieved by varying the doping parameters and/or resin selection. To realize this resistivity the ratio of the weight of the conductor material, in this example the conductor particles 34 or conductor fibers 38, to the weight of the base resin host 30 is between about 0.20 and 0.40, and is preferably about 0.30. Stainless Steel Fiber of 8-11 micron in diameter and lengths of 4-6 mm with a fiber weight to base resin weight ratio of 0.30 will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 homogenized together within the resin base 30 during a molding process.

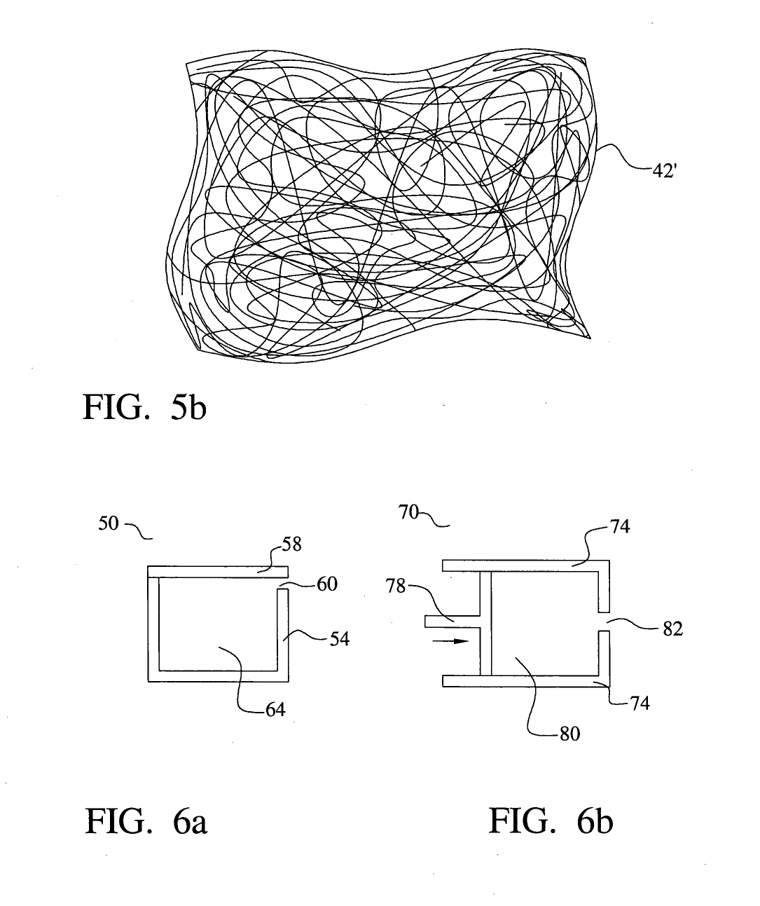

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Devices or structures formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the homogenized conductive material cures by thermal reaction. The upper portion 58 and lower portion 54 of the mold are then separated or parted and the devices or structures are removed.

FIG. 6b shows a simplified schematic diagram of an extruder 70 for forming devices or structures using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use.

The advantages of the present invention may now be summarized. A method to form a metal layer on a conductive loaded resin-based material is achieved. Various devices and structures are formed of metal-plated, conductive loaded resin-based materials. A method to alter visual, thermal, mechanical, and/or electrical characteristics of a conductive-loaded resin-based is achieved by forming a metal layer over the conductive loaded resin-based material. A method to electrically and/or thermally interface a conductive loaded resin-based device or structure is achieved by means of a metal layer formed thereon.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

What is claimed is:

1. A device comprising:
a conductive loaded, resin-based material comprising conductive materials in a base resin host wherein said base resin host is platable; and
a plated metal layer overlying said conductive loaded, resin-based material.

2. The device according to claim 1 wherein the ratio, by weight, of said conductive materials to said resin host is between about 0.20 and about 0.40.

3. The device according to claim 1 wherein said conductive materials comprise metal powder.

4. The device according to claim 3 wherein said metal powder is nickel, copper, or silver.

5. The device according to claim 3 wherein said metal powder is a non-conductive material with a metal plating.

6. The device according to claim 5 wherein said metal plating is nickel, copper, silver, or alloys thereof.

7. The device according to claim 3 wherein said metal powder comprises a diameter of between about 3 μm and about 12 μm.

8. The device according to claim 1 wherein said conductive materials comprise non-metal powder.

9. The device according to claim 8 wherein said non-metal powder is carbon, graphite, or an amine-based material.

10. The device according to claim 1 wherein said conductive materials comprise a combination of metal powder and non-metal powder.

11. The device according to claim 1 wherein said conductive materials comprise micron conductive fiber.

12. The device according to claim 11 wherein said micron conductive fiber is nickel plated carbon fiber, stainless steel fiber, copper fiber, silver fiber or combinations thereof.

13. The device according to claim 11 wherein said micron conductive fiber has a diameter of between about 3 μm and about 12 μm and a length of between about 2 mm and about 14 mm.

14. The device according to claim 1 wherein said conductive materials comprise a combination of conductive powder and conductive fiber.

15. The device according to claim 1 wherein said plated metal layer is copper, tin, nickel, zinc, chromium, silver, or gold.

16. The device according to claim 1 wherein said plated metal layer is solderable.

17. The device according to claim 1 wherein said plated metal layer is formed by electroless plating.

18. The device according to claim 1 wherein said plated metal layer is formed by electroplating.

19. The device according to claim 1 wherein said device is an antenna.

20. The device according to claim 1 further comprising a non-platable material fixably coupled to said conducitive loaded resin-based material wherein said plated metal layer does not overlie said non-platable material.

21. The device according to claim 20 wherein said non-platable material comprises a resin-based material.

22. The device according to claim 20 wherein said non-platable material is a printable ink.

23. The device according to claim 1 further comprising a platable insulating layer between said conductive loaded resin-based material and said plated metal layer.

24. The device according to claim 23 wherein said device is an antenna.

25. A method to form a device, said method comprising:
providing a conductive loaded, resin-based material comprising conductive materials in a resin-based host;
molding said conductive loaded, resin-based material into a device; and
plating a metal layer overlying said device.

26. The method according to claim 25 wherein the ratio, by weight, of said conductive materials to said resin host is between about 0.20 and about 0.40.

27. The method according to claim 25 wherein the conductive materials comprise a conductive powder.

28. The method according to claim 25 wherein said conductive materials comprise a micron conductive fiber.

29. The method according to claim 25 wherein said conductive materials comprise a combination of conductive powder and conductive fiber.

30. The method according to claim 25 wherein said molding comprises:
injecting said conductive loaded, resin-based material into a mold;
curing said conductive loaded, resin-based material; and
removing said device from said mold.

31. The method according to claim 25 further comprising forming a non-platable masking layer over a part of said device.

32. The method according to claim 31 wherein said step of plating a metal layer overlying said device does not form said metal layer over said non-platable masking layer.

33. The method according to claim 31 wherein said step of forming a non-platable masking layer over a part of said device comprises molding a non-platable resin-based material.

34. The method according to claim 31 wherein said step of forming a non-platable masking layer over a part of said device comprises printing a non-platable ink.

35. The method according to claim 25 wherein said plated metal layer is formed by electroless plating.

36. The method according to claim 25 wherein said plated metal layer is formed by electroplating.

37. The device according to claim 25 wherein said plated metal layer is copper, tin, nickel, zinc, chromium, silver, or gold.

38. The device according to claim 25 wherein said plated metal layer is solderable.

39. The method according to claim 25 wherein said molding comprises:
loading said conductive loaded, resin-based material into a chamber;
extruding said conductive loaded, resin-based material out of said chamber through a shaping outlet; and
curing said conductive loaded, resin-based material to form said device.

40. The method according to claim 39 further comprising stamping or milling said molded conductive loaded, resin-based material.

41. The method according to claim 25 further comprising forming a platable, insulating layer overlying said conductive loaded resin-based material prior to said step of plating a metal layer.

42. A method to form a device, said method comprising:
providing a conductive loaded, resin-based material comprising conductive materials in a resin-based host;
molding said conductive loaded, resin-based material into a device;
forming a non-platable masking layer over a part of said device; and
plating a metal layer overlying said device wherein said metal layer is not formed over said non-platable masking layer.

43. The method according to claim 42 wherein the ratio, by weight, of said conductive materials to said resin host is between about 0.20 and about 0.40.

44. The method according to claim 42 wherein the conductive materials comprise a conductive powder.

45. The method according to claim 42 wherein said conductive materials comprise a micron conductive fiber.

46. The method according to claim 42 wherein said conductive materials comprise a combination of conductive powder and conductive fiber.

47. The method according to claim 42 wherein said molding comprises:
injecting said conductive loaded, resin-based material into a mold;
curing said conductive loaded, resin-based material; and
removing said device from said mold.

48. The method according to claim 42 wherein said step of forming a non-platable masking layer over a part of said device comprises molding a non-platable resin-based material.

49. The method according to claim 42 wherein said step of forming a non-platable masking layer over a part of said device comprises printing a non-platable ink.

50. The method according to claim 42 wherein said plated metal layer is formed by electroless plating.

51. The method according to claim 42 wherein said plated metal layer is formed by electroplating.

52. The device according to claim 42 wherein said plated metal layer is copper, tin, nickel, zinc, chromium, silver, or gold.

53. The device according to claim 42 wherein said plated metal layer is solderable.

54. The method according to claim 42 wherein said molding comprises:
loading said conductive loaded, resin-based material into a chamber;
extruding said conductive loaded, resin-based material out of said chamber through a shaping outlet; and
curing said conductive loaded, resin-based material to form said device.

55. The method according to claim 54 further comprising stamping or milling said molded conductive loaded, resin-based material.

56. The method according to claim 42 further comprising forming a platable, insulating layer overlying said conductive loaded resin-based material prior to said step of plating a metal layer.
